(19) United States
(12) Patent Application Publication
(10) Pub. No.: US 2008/0315021 A1
(43) Pub. Date: Dec. 25, 2008

(54) Adjustable Condiment Grinder

(76) Inventor: Yu Wing Tang, Hong Kong (HK)

Correspondence Address: Robert D. Katz;Cooper & Dunham LLP, 1185 Avenue of the Americas, New York, NY, 10036, US

(21) Appl. No.: 11/765,014

(22) Filed: Jun. 19, 2007

(51) Int. Cl. A47J 42/34

(52) U.S. Cl. 241/169.1

(57) ABSTRACT

Inner and outer grinding elements have a space therebetween which defines the size of the ground product. A shaft is connected at its bottom end to the inner element for operating the grinder. A sleeve extends about the outer grinding element and is mounted for rotation about the central axis of the grinding elements. Mating screw threads are formed on the sleeve and outer grinding element such that rotation of the sleeve moves the outer grinding element axially for adjusting the size of the ground condiment. A knob accessible from the exterior of the lower housing is fixed to the sleeve and rotates in a circumferential slot in the lower housing.

### TECHNICAL FIELD

The present invention relates to grinders for condiments such as pepper or salt, and particularly to grinders with means for adjusting the size of the ground condiment.

### BACKGROUND OF THE INVENTION

In a traditional condiment grinder the housing defines a condiment reservoir and a rotary handle at the top of the housing is connected by a shaft to a grinding mechanism at the bottom of the housing. The grinding mechanism includes coaxial inner and outer grinding elements, the space between which defines the size of the ground product. The outer element is fixed to the housing and the shaft is connected at its bottom end to the inner element and at its top end by a screw threaded knob to the handle. Rotation of the knob allows the axial position of the inner element to be varied to adjust the fineness of the ground product. The adjusting knob protrudes from the handle and when rotating the handle the knob may also be unintentionally rotated together with the handle or by contact with the user's hand. As the pitch of the screw thread on the knob is fine and the knob is relatively small, the angular position of the knob does not provide a satisfactory visual indicator of the state of fineness adjustment. It is an object of the present invention to overcome or substantially ameliorate the above disadvantages or more generally to provide an improved condiment grinder.

### DISCLOSURE OF THE INVENTION

According to one aspect of the present invention there is provided a condiment

grinder comprising:
a housing;
a shaft having a central axis supported for rotation in the housing;
an inner grinding element fixed at a first end of the shaft;
an outer grinding element mounted substantially coaxially with the inner grinding element to define a space therebetween for receiving the condiment to be ground;
a sleeve extending about the outer grinding element and mounted to the housing for rotation about the central axis, the sleeve being fixed axially with respect to the housing, and
mating screw threads formed on the sleeve and outer grinding element such that rotation of the sleeve moves the outer grinding element axially for adjusting the size of the ground condiment.

The housing preferably includes a lower cylindrical wall substantially enclosing the sleeve, a circumferential slot is formed in the cylindrical wall and a knob fixed to the sleeve extends through the slot allowing the knob to be grasped for rotating the sleeve. Alternatively the sleeve may be exposed at the lower part of the housing, allowing the sleeve to be grasped directly for rotation thereof.

Preferably circumferentially-spaced indicia are provided externally on the housing adjacent the slot to indicate the maximum size of ground condiment dispensed from the grinder.

Preferably the housing defines a reservoir, the grinder further includes a rotary handle engaging an upper end of the housing to close a mouth of the reservoir, the handle being rotationally fast with a second end of the shaft opposing the first end, the handle being removable axially to open the mouth of the reservoir,

The screw threads are preferably multiple-start screw threads.

Preferably axially opposing ends of the outer grinding element engage respective coaxial faces throughout the movement of the outer grinding element.

By providing the sleeve for adjusting the grinder on the body away from the handle the opportunity for inadvertent adjustment is reduced and the handle is able to have a smoother external appearance. Moreover, the grinder may be economically constructed. The small angular movement of the sleeve means that the position of the knob along the slot provides a good visual indicator of the state of adjustment of the grinder.

### BRIEF DESCRIPTION OF THE DRAWINGS

Preferred forms of the present invention will now be described by way of example with reference to the accompanying drawings, wherein:

FIG. 1 is a side view of a preferred embodiment of the grinder of the invention;

FIG. 2 is a section along line AA of FIG. 1;

FIG. 3 is a central longitudinal cross section of the grinder of FIG. 1, and

FIG. 4 is an exploded view of the grinder of FIG. 1.

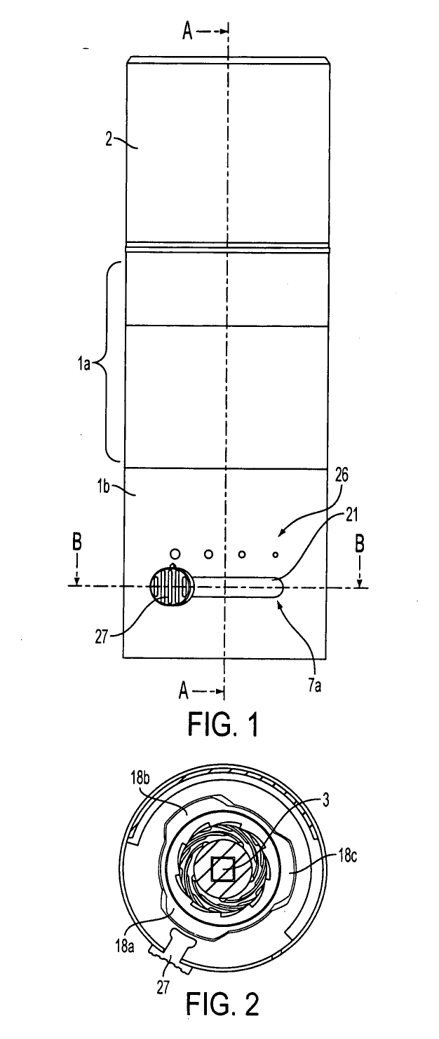

### DESCRIPTION OF THE PREFERRED EMBODIMENTS

Referring to the drawings a manual grinder includes an upper housing 1a with cylindrical walls enclosing a reservoir 30 for receiving condiments such as peppercorns and rock salt. The handle 2 receives the upper end of an elongate shaft 3 having a longitudinal axis 4. As used herein, the term “axial” refers to a direction substantially parallel to the longitudinal axis 4. The term “radial” refers to a direction substantially orthogonal to the longitudinal axis 4. The term “circumferential” refers to the direction of a circular arc having a radius substantially orthogonal to the longitudinal axis 4.

The shaft 3 has a square section and the handle 2 has an aperture 5 with a complementary square section, allowing the handle 2 to rotate shaft 3 and to be removed axially for opening an upper mouth 29 of the reservoir 30.

Fixed to the upper housing 1a, the lower housing 1b is assembled from substantially cylindrical inner and outer collars 6, 7 each with respective circumferential slots 6a, 7a. Circumferentially-spaced indicia 26 are provided externally on the outer collar 7 adjacent the slot 7a to indicate the maximum size of ground condiment dispensed from the grinder. The upper and lower housings 1a, 1b are rotationally fast with one another, being connected by resilient engagement between respective annular flanges 8, 9.

A shaft mount 10 is also fixed to the upper housing 1a by an interference fit between contacting circumferential surfaces 13. The shaft mount 10 is has upper and lower ring-shaped portions 10a, 10b joined by arms 10c. An axial aperture 11 in the upper portion 10a receives the shaft 3 for rotation therein and is located axially by circlips 14a. Openings 12 between the arms 10c are provided for the passage of the condiment.

Rotationally fast with the lower end of the shaft 3 and axially located between circlips 14b is an inner grinding element 15 having a tapered external grinding surface 15a.

An outer grinding element 16 has an internal grinding surface 17 for cooperating with grinding surface 15a to grind the condiment therebetween. The grinding element 16 is assembled from first and second parts 16a, 16b which are permanently connected, as by an interference fit. A three-start screw thread 18 has three flights 18a, 18b, 18c formed externally on the outer grinding element 16, specifically on the first part 16a, which also includes a central through-extending opening 28. A cylindrical projection 22 extends upwardly from the termination of the thread 18.

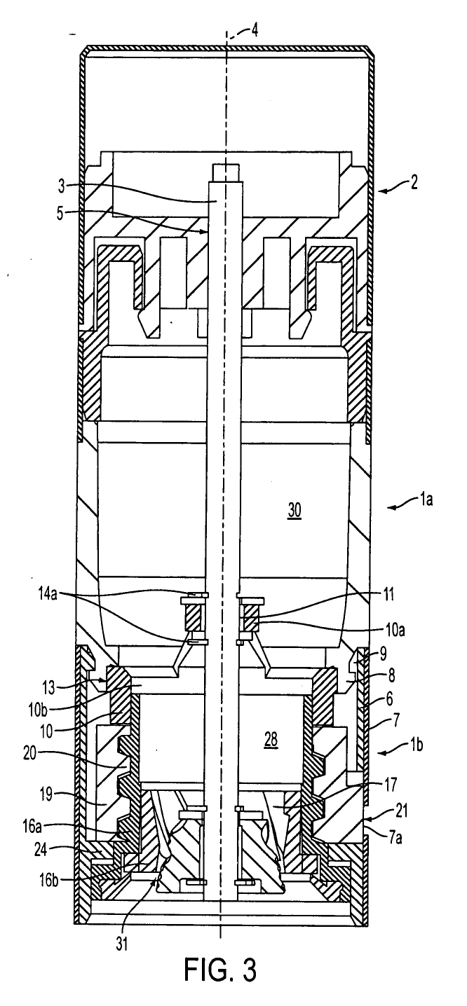

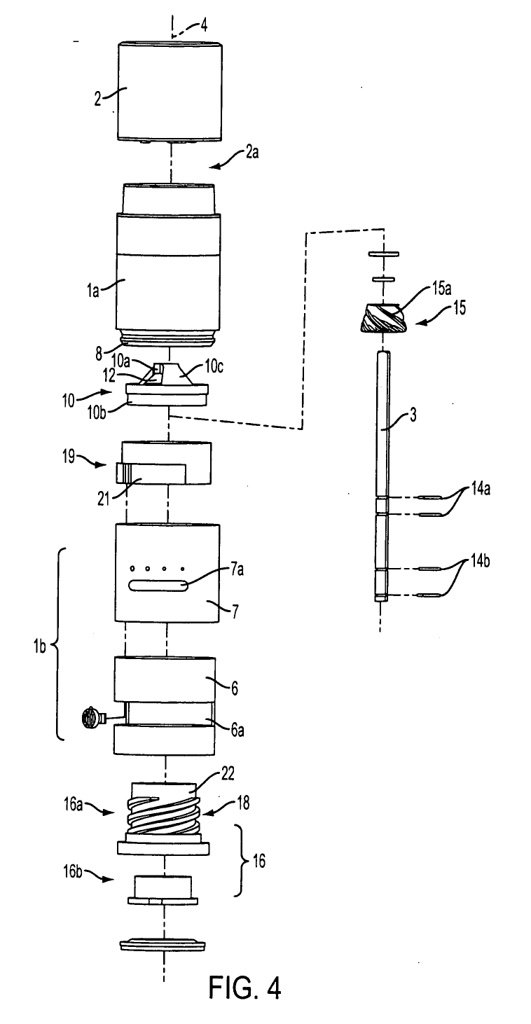

A sleeve 19 includes a three-start screw thread 20 formed internally and an external circumferentially-extending cylindrical face 21. As best seen in FIG. 3, the sleeve 19 is received for rotation in the lower housing 1b and is located axially between the lower portion of the shaft mount 10 and a shoulder 24 formed internally on the inner collar 6. With the threads 18, 20 engaged, the outer grinding element 16 is located radially at its upper end by the cylindrical projection 22 received in the lower ring-shaped portion 10b and at its lower end by engagement with the lower housing lb.

A knob 27 is fixed to the sleeve 19 and extends radially outwardly through the slot 7a. A point 33 on the knob 27 is provided for alignment with the indicia 26.

In use the openings 12 and central through-extending opening 28 provide passageway from the larger reservoir 30 to the grinding mechanism. The handle 2 is rotated about axis 4 to turn the attached inner grinding element 15. The condiment is ground between the grinding surfaces 15a, 17 falling between the substantially annular aperture 31 between the inner and outer grinding elements 15, 16 to dispense the condiment from the lower end of the housing 1b.

To adjust the size of ground condiment, the user grasps the knob 27 and thereby rotates the attached sleeve 19 relative to the upper and lower housing parts 1a, 1b. As the sleeve 19 is restrained axially and the outer grinding element 16 is able to move axially (but is restrained from rotating) the cooperation between the screw threads 18, 20 moves the outer grinding element 16 axially upon rotation of the sleeve 19. By virtue of the tapered shape of the inner grinding element 15 this movement varies the radial dimension 31, which is increased to produce larger particles and reduced to produce smaller particles.

Aspects of the present invention have been described by way of example only and it should be appreciated that modifications and additions may be made thereto without departing from the scope thereof.

1. A condiment grinder comprising:
a housing;
a shaft having a central axis supported for rotation in the housing;
an inner grinding element fixed at a first end of the shaft;
an outer grinding element mounted substantially coaxially with the inner grinding element to define a space therebetween for receiving the condiment to be ground;
a sleeve extending about the outer grinding element and mounted to the housing for rotation about the central axis, the sleeve being fixed axially with respect to the housing, and
mating screw threads formed on the sleeve and outer grinding element such that rotation of the sleeve moves the outer grinding element axially for adjusting the size of the ground condiment.

2. The grinder of claim 1 wherein the housing includes a lower cylindrical wall substantially enclosing the sleeve, a circumferential slot is formed in the cylindrical wall and a knob fixed to the sleeve extends through the slot allowing the knob to be grasped for rotating the sleeve.

3. The grinder of any one of the preceding claims wherein circumferentially-spaced indicia are provided externally on the housing adjacent the slot to indicate the maximum size of ground condiment dispensed from the grinder.

4. The grinder of one of the preceding claims wherein the housing defines a reservoir, the grinder further includes a rotary handle engaging an upper end of the housing to close a mouth of the reservoir, the handle being rotationally fast with a second end of the shaft opposing the first end, the handle being removable axially to open the mouth of the reservoir,

5. The grinder of one of the preceding claims wherein the screw threads are multiple-start screw threads.

6. The grinder of one of the preceding claims wherein axially opposing ends of the outer grinding element engage respective coaxial faces throughout the movement of the outer grinding element.
